(19) United States
(12) Patent Application Publication
(10) Pub. No.: US 2026/0271967 A1
(43) Pub. Date: Sep. 17, 2026

(54) COLLAGEN-INFUSED DENTAL PET CHEW

(71) Applicant: MPet Group Corp., Aventura, FL (US)

(72) Inventor: Abraham G. Mendal, Aventura, FL (US)

(21) Appl. No.: 19/249,803

(22) Filed: Jun. 25, 2025

Related U.S. Application Data
(60) Provisional application No. 63/772,273, filed on Mar. 14, 2025.

(51) Int. Cl. A23K 20/147; A23K 40/25; A23K 50/40

(52) U.S. Cl. CPC A23K 20/147; A23K 40/25; A23K 50/40

(57) ABSTRACT

A process and a product for preparing a collagen-infused dental pet chew are disclosed. In some embodiments, the disclosed collagen-infused dental pet chew includes a hard, optionally ridged, exterior with a soft toothpaste center. Collagen is infused in the disclosed collagen-infused dental pet chew (e.g., in a single mixture for the chew, in an exterior mixture of the chew, or in an exterior mixture and interior mixture of the chew). The collagen supports dental, bone, and skin health for pets (e.g., canines).

### CROSS REFERENCE TO OTHER APPLICATIONS

This application claims priority to U.S. Provisional Patent Application No. 63/772,273 entitled COLLAGEN-INFUSED DENTAL PET CHEW filed Mar. 14, 2025, which is incorporated herein by reference for all purposes.

### BACKGROUND OF THE INVENTION

Dental pet chews are widely used to promote oral hygiene in pets, such as canines (e.g., dogs), by mechanically cleaning teeth through chewing action. For example, some existing dental pet chews utilize a hard outer surface molded into a toothbrush-like shape (e.g., with bristles) and an inner chamber filled with a purported toothpaste-like substance. These designs aim to clean pets' teeth via external abrasion from the hard surface and chemical action from their active ingredient.

Generally, existing dental pet chews typically utilize a singular shape and formula with beveled surfaces (e.g., a star shape) to help with the abrasive action of dental cleaning; or a coextruded shape with the same formula on the inside and outside except for simply changing the interior color of the treat giving the illusion of “filling” their treat with toothpaste.

### BRIEF DESCRIPTION OF THE DRAWINGS

Various embodiments of the invention are disclosed in the following detailed description and the accompanying drawings.

FIG. 1 illustrates a process for preparing a collagen-infused dental pet chew in accordance with some embodiments.

FIGS. 2A-2E illustrate example shapes of a collagen-infused dental pet chew resulting from the process described above with respect to FIG. 1 in accordance with some embodiments.

FIGS. 3A and 3B illustrate example lab testing results for dental pet chew durability testing.

### DETAILED DESCRIPTION

The invention can be implemented in numerous ways, including as a process; and/or a composition of matter. In this specification, these implementations, or any other form that the invention may take, may be referred to as techniques. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Dental pet chews are widely used to promote oral hygiene in pets, such as canines, by mechanically cleaning teeth through chewing action. For example, some existing dental pet chews typically utilize a hard outer surface molded into a toothbrush-like shape with bristles and an inner chamber filled with toothpaste or a similar substance. These designs aim to clean pets' teeth via external abrasion from the hard surface and chemical action from their active ingredient.

Generally, existing dental pet chews typically utilize a singular shape and formula with beveled surfaces (e.g., a star shape) to help with the abrasive action of dental cleaning; or a coextruded shape with the same formula on the inside and outside except for simply changing the interior color of the treat giving the illusion of “filling” their treat with toothpaste.

Moreover, the materials typically do not contribute to broader health benefits, such as bone, skin, and/or gum health.

Moreover, conventional processes for producing these chews rely on standard baking or extrusion methods that achieve hardness but fail to integrate certain ingredients such as collagen throughout the chew for enhanced dental and systemic health benefits (e.g., in which collagen can provide dental health benefits for teeth, gum, and jaws). Moreover, conventional processes for producing these chews fail to integrate both collagen and dental plaque reducers. Additionally, the formulation that they typically utilize produces less durable chews (e.g., thereby providing less time spent mechanically cleaning the pet's teeth, such as dental chews from Greenies®).

Also, collagen is an important foundation of mammalian bodies (e.g., making up as much as 35%). For example, collagen is found in the dentin, cementum, and enamel of teeth and gums. In dental studies of humans, for example, collagen is used as a biomatrix or scaffold to regenerate gums in periodontal disease or following tooth removal. See Naomi, R.; Ardhani, R; Hafiyyah, O A; Fauzi, M B, Current Insight of Collagen Biomatrix for Gingival Recession: An Evidence-Based Systemic Review, Polymers, 2020, 12, 2081; doi:10.3390/polm12092081.

As such, there exists a need for a dental pet chew that combines a hard, abrasive exterior (e.g., toothbrush-like hardness) with a soft, functional toothpaste center that uses a natural, collagen-rich composition for enhanced teeth-cleaning and additional health benefits for pets. Further, there is a need for providing collagen integrated on both the exterior and the interior of pet chews for enhanced benefits. Also, there is a need for a longer lasting dental pet chew to facilitate a more effective dental cleaning for pets.

Accordingly, a process for preparing and a product (e.g., including a product-by-process) for a collagen-infused dental pet chew are disclosed in accordance with various embodiments.

In some embodiments, a collagen-infused dental pet chew and a process for its preparation are disclosed, comprising a unique composition and cooking method that integrate collagen throughout the chew to facilitate abrasive teeth-cleaning action both internally and externally, while promoting healthy teeth and skin. Specifically, by providing collagen in the exterior of the dental pet chew, such infused collagen facilitates a more durable dental pet chew, enhances abrasion for improved teeth cleaning action provided by the dental pet chew, and, thus, provides for cleaner teeth while also providing the dental health benefits associated with collagen for teeth as discussed above.

Moreover, as discussed above, there is a need for a longer lasting dental pet chew to facilitate a more effective dental cleaning for pets. As such, the addition of collagen also provides for a more durable, longer lasting dental pet chew to facilitate a more effective dental cleaning for pets.

Specifically, a collagen-infused dental pet chew and an extrusion cooking process for its preparation, featuring a hard exterior (e.g., optionally with ridges) for abrasive action and, in some embodiments, the collagen-infused dental pet chew also includes a soft toothpaste center infused with natural active ingredients (e.g., examples of such active ingredients can include one or more of the following: botanicals, such as herbs or spices; marine plants, such as seaweed or kelp; sugar alcohols, such as erythritol; fermentation products, such as yeast; and/or minerals, such as charcoal, ash, etc.) are disclosed in accordance with some embodiments. The chew includes collagen as an ingredient. The collagen can be sourced from bovine, porcine, avian, marine (e.g., the marine source of collagen can be derived from Anguilliformes, elasmobranchs, mollusks, and/or other marine sources), ovine, or plantae origins (e.g., the plantae source of collagen can be derived from including seaweed, microalgae, fruits, legumes, vegetables, herbs, spices, and/or other plantae sources). In an example implementation, the ingredients for the exterior of the chew can also include a protein (e.g., at least 20%) natural formulation. In some embodiments, the formulation is all natural without synthetic chemicals or dyes.

The extrusion cooking process can utilize medium-high heat/shear for the hard exterior (e.g., a ridged exterior) and minimal-low heat/shear for the toothpaste center. The ingredients for the interior of the chew (e.g., the toothpaste substance/material) can include, for example, alfalfa, parsley, cinnamon. The parsley provides for a natural green coloring/specs of the interior of the chew product; alfalfa provides for a natural green exterior coloring of the chew product; and spearmint extract, mint extract, and/or cinnamon extract provides for breath freshening benefits.

In an example implementation, coconut oil is used as an ingredient for the toothpaste center to provide the toothpaste texture. Also, coconut oil has proven benefits for dental hygiene and oral health. Specifically, coconut oil can reduce bacteria and plaque for the teeth and the mouth microbiome.

Unlike prior dental chews with ridges on their exteriors and purported toothpaste chambers that utilize the same/similar substances/materials (e.g., but may merely alter the color of the interior substances/materials to provide an appearance of a distinct toothpaste filler), the disclosed collagen-infused dental pet chew integrates collagen, which enhances internal and external dental cleaning. Moreover, the infused collagen supports dental, bone, and skin health.

Moreover, no other dental pet chews include collagen as a main ingredient. The disclosed dental pet chews include collagen as an ingredient. The infused collagen supports dental, bone, and skin health as similarly discussed above. Also, the infused collagen provides for a longer lasting dental pet chew that facilitates improved teeth cleaning as also discussed above.

Also, the disclosed cooking process for the collagen-infused dental pet chew is used to achieve a desired consistency, which provides a chew with toothbrush-like hardness (e.g., with exterior ridges) while infusing collagen as a significant ingredient.

Specifically, the collagen that is infused in the chew enhances abrasiveness throughout the chew, which provides significant benefits beyond surface-level action. For example, the collagen that is infused in the chew also delivers documented dental, bone, and skin health benefits, such as improved gum strength and reduced tartar buildup as similarly described above.

Further, the disclosed collagen-infused pet chew's composition includes distinct ingredients to balance hardness and collagen infusion, thereby further distinguishing it from conventional chews that typically rely on external hardness.

In some embodiments, the disclosed collagen-infused pet chew's composition also includes a different composition for an inner chamber that provides a toothpaste formulation for enhanced dental cleaning for pets (e.g., canines/dogs).

Finally, the disclosed process for preparing and a product (e.g., including a product-by-process) for a collagen-infused dental pet chew employs an extrusion cooking process to achieve long-lasting consistency and digestibility.

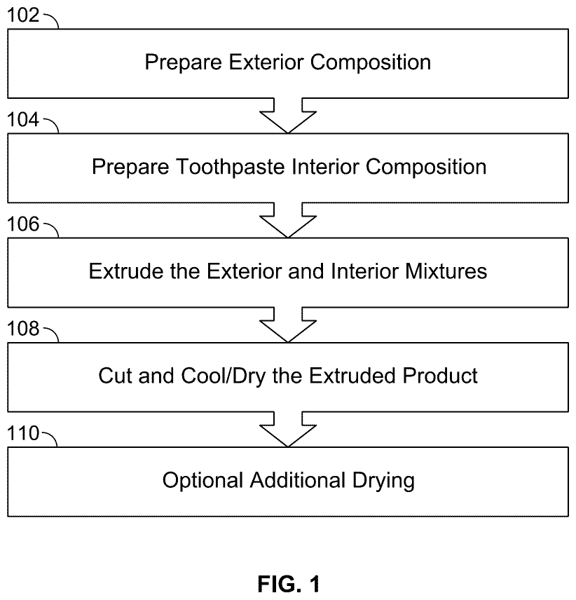

In an example implementation, the extrusion cooking process includes taking raw materials and extruding them in a barrel while applying heat to change the characteristic of the material (e.g., which contributes to the long-lasting characteristic associated with the disclosed collagen-infused dental pet chews). Specifically, as will be further described below with respect to FIG. 1, co-extrusion can be utilized for producing the disclosed collagen-infused dental pet chews by combining two extruders to generate one shape for producing a hard collagen exterior and a softer toothpaste-like interior.

The collagen-infused dental pet chew of the present invention is prepared using, for example, the disclosed cooking process that infuses collagen into the dental pet chew, while maintaining an exterior with adequate hardness to facilitate abrasive action for teeth cleaning. The process and composition are detailed below, such as will now be further described with respect to FIG. 1.

FIG. 1 illustrates a process for preparing a collagen-infused dental pet chew in accordance with some embodiments.

In an example implementation, the collagen-infused dental pet chew is a dual-texture product prepared via a co-extrusion process, combining a hard exterior (e.g., optionally, including ridges) with collagen as a key ingredient for abrasiveness and dental/other health benefits and optionally further including a soft toothpaste center.

Referring to FIG. 1, the process includes the following steps to produce a collagen-infused dental pet chew, such as will now be described below.

At 102, preparing an exterior composition for the collagen-infused dental pet chew is performed to create an exterior mixture for extrusion. In an example implementation, a mixture is prepared comprising 15% by weight collagen (e.g., collagen powder sourced from bovine, porcine, avian, marine, ovine, or plantae; or alternatively, collagen in the form of gelatin can similarly be used), 35% by weight starch (e.g., tapioca), and 5% flavoring (e.g., natural flavoring, such as using chicken, or, optionally, artificial flavoring, or, preferably, for an all-natural pet chew -no such artificial flavoring is added as similarly described above). In this example embodiment, the total protein is at least 20% by weight.

At 104, preparing a toothpaste interior composition for the collagen-infused dental pet chew is performed to create an interior mixture for extrusion. In an example implementation, a soft mixture is prepared with 30% by weight glycerin, 10% by weight water (or alternatively, steam by product of cook extrusion processing can be used instead of adding water to the pre-blend, also known as the soft mixture), 15% by weight starch, and 15% by weight active ingredients including collagen in the form of gelatin (e.g., coconut oil and/or kelp meal, which are shown to reduce plaque and tartar, and/or similar ingredients). Optional additives of active ingredients can include botanicals (e.g., herbs/spices), marine plants (e.g., seaweed/kelp), sugar alcohols (e.g., erythritol), yeast fermentation products, and/or other minerals, vitamins, etc. The interior composition can also optionally include collagen, such as similarly described above with respect to the exterior composition.

In an example implementation, hydrolyzed collagen, or any type of collagen ingredient, or alternatively, gelatin, can be infused in the exterior and/or interior mixtures. Generally, hydrolyzed collagen is more bioavailable, being absorbed into the blood stream faster than native collagen. This is because during the hydrolysis process, the triple helix is cleaved into long chains and then into shorter chains of amino acids, namely groups of hydroxyproline, glycine, and proline. Smaller peptides are readily absorbed in the intestine and transported via the circulatory system to wherever the body needs it.

Collagen benefits are generally based on the type of collagen (e.g., there are at least 28 types of collagen identified). For example, Type I collagen is the most abundant type of collagen and generally supports a healthy dermis including the lining of the intestine, bones, ligaments, tendons, and teeth. Type II collagen is mainly used by the body to support joint health/cartilage. Type III collagen is typically used to support muscles, organs, arteries, and teeth.

In this example implementation, various types including Type III collagen can be infused into the collagen-infused pet chews to facilitate improved dental health as well as other health benefits as similarly described above and further described below. As also discussed above, the infusion of collagen in the dental pet chew provides for increased durability to facilitate enhanced teeth cleaning for pets.

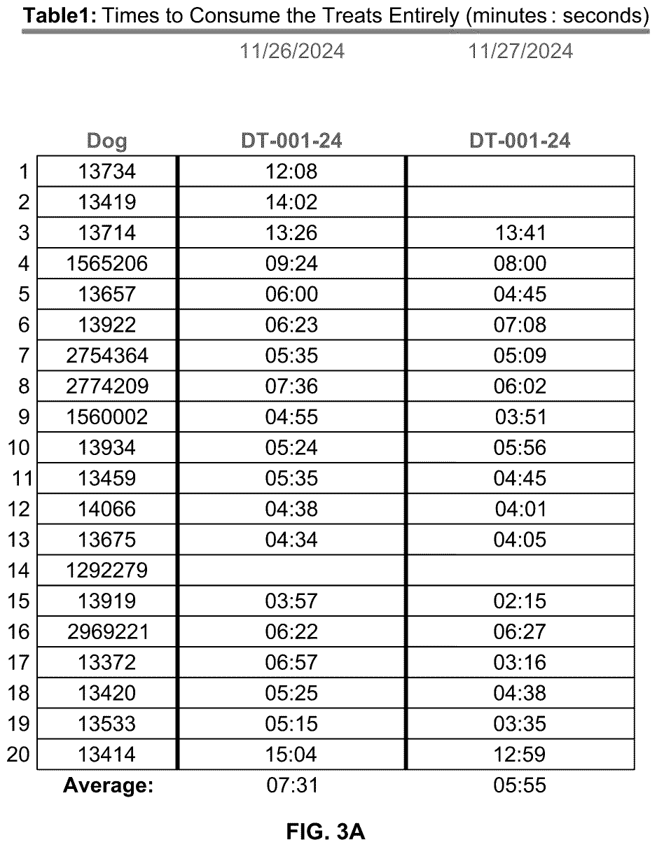

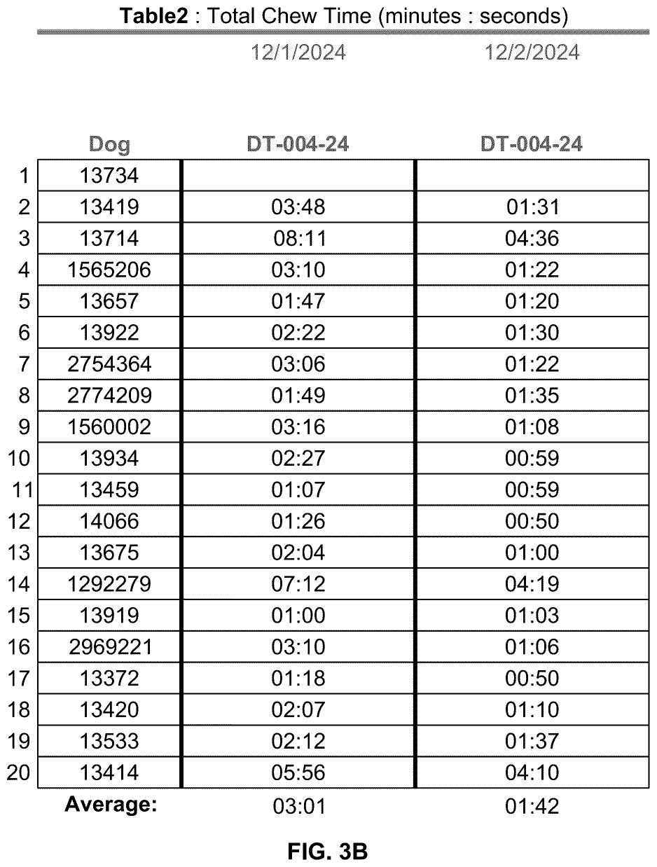

FIGS. 3A and 3B illustrate example lab testing results for dental pet chew durability testing.

Specifically, by adding collagen to the formula for processing and manufacturing the collagen infused chew, e.g., 15% weight by collagen in disclosed embodiments, provides for significantly improved and unexpected results in greater chew durability as shown in Table 1 (e.g., providing lab testing results for times to consume the treats entirely (minutes:seconds)) in FIG. 3A as compared with example test results shown in Table 2 (e.g., providing lab testing results for total chew times (minutes:seconds)) in FIG. 3B of a competitor chew product without infused collagen. As such, it is evident based on these durability/chew time lab testing results between our product and a competitor with the same shape, weight, and diameter, that the disclosed collagen infused dental pet chew achieves the top results, for example, averaging double as long chew times as the competitor as shown in Table 2 of FIG. 3B.

Specifically, collagen is found in the dentin, cementum, and enamel of teeth and the gums. As an example, in dental studies of humans, collagen is used as a biomatrix or scaffold to regenerate gums in periodontal disease or following tooth removal. See Naomi, R.; Ardhani, R.; Hafiyyah, O A; Fauzi, M B., Current Insight of Collagen Biomatrix for Gingival Recession: An Evidence-Based Systematic Review, Polymers, 2020, 12, 2081; doi:10.3390/polm12092081. As another example, low molecular weight collagen peptides, such as those from the hydrolyzed version of collagen, are absorbed rapidly in the blood stream, supporting an increase in organic content of bone. See Watanabe-Kamiyama, M. et al., Absorption and Effectiveness of Orally Administered Low Molecular Weight Collagen Hydrolysate in Rats, J. Agric. Food Chem. 2010, 58, 835-842 DOI:10.1021/jf9031487.

At 106, extruding the exterior mixture and separately extruding the interior mixture (e.g., using a co-extrusion process, such as extruded into a predetermined shape using a die on the extruder; alternatively, a mold injection process can similarly be used for providing the predetermined shape) is performed. In an example implementation, the exterior mixture is processed in a first extruder at a feed rate of approximately 900 pounds per hour, at medium-high heat (e.g., average product temperature of approximately 200 degrees Fahrenheit) and medium-high shear stress (e.g., approximately 200 revolutions per minute (rpm) screw speed), extruded through a die with, in this example, ridge-forming channels to create an abrasive, hard outer layer (e.g., Shore D hardness 60-70). In this example implementation, to form the soft toothpaste in the interior of the collagen-infused pet chew, the interior mixture is processed using a second extruder/pump at, for example, a feed rate of approximately 550 pounds per hour, at medium-high heat (e.g., average product temperature of approximately 200 degrees Fahrenheit) and medium-high shear stress (e.g., approximately 170 revolutions per minute (rpm) screw speed), and then co-extruded into an interior/core of the exterior layer, retaining a soft consistency to provide the soft toothpaste filling for the collagen-infused pet chew.

In another embodiment, the collagen-infused dental pet chew is a single mixture that includes collagen as an ingredient that is infused into the single mixture and extruded into a pet chew in one or more shapes and dimensions.

At 108, cutting and then cooling the extruded product is performed. In an example implementation, the co-extruded product is cooled to approximately 25 degrees Celsius for the product temperature, for example, on a cooling conveyer for a predetermined period of time (e.g., such as between 20 minutes to 30 minutes depending on the thickness and/or desired moisture level (e.g., or water activity (aw)) of the pet chew) and then cut into chew-sized pieces (e.g., 4 inches, 6 inches, 9 inches, and/or 12 inches long with varying diameters, such as 0.5 inches, 1.0 inches, 1.5 inches, or various other dimensions can similarly be used for the chews, along with varying shapes of dies for the chews).

At 110, optional additional drying is performed for the dental pet chew (e.g., air-dried at room temperature or another drying mechanism can similarly be used, such as between 20 minutes up to approximately 24 hours depending on the thickness and/or desired moisture level to a moisture content of approximately 10-20% (e.g., or water activity (aw)) of the pet chew), thereby ensuring long-lasting durability and digestibility for the resulting collagen-infused dental pet chews.

As such, the resulting shaped product provides a collagen-infused dental pet chew.

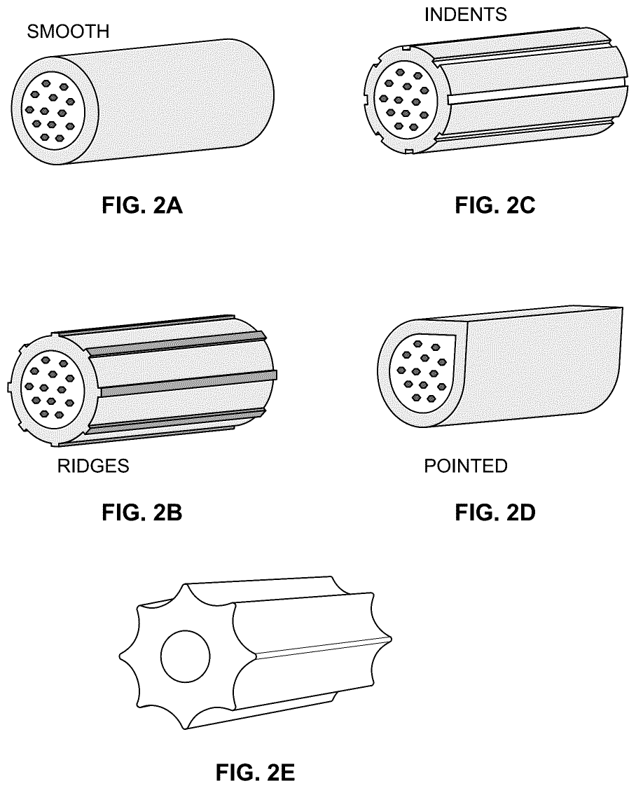

FIGS. 2A-2E illustrate example shapes of a collagen-infused dental pet chew resulting from the process described above with respect to FIG. 1 in accordance with some embodiments.

As shown in FIG. 2A, the collagen-infused dental pet chew includes an exterior composition that includes a hard, smooth exterior in this example. The collagen-infused dental pet chew also includes an interior composition that provides the toothpaste as similarly described above with respect to FIG. 1.

As shown in FIG. 2B, the collagen-infused dental pet chew includes an exterior composition that includes outer ridges in this example. The collagen-infused dental pet chew also includes an interior composition that provides the toothpaste as similarly described above with respect to FIG. 1.

As shown in FIG. 2C, the collagen-infused dental pet chew includes an exterior composition that includes indents in this example. The collagen-infused dental pet chew also includes an interior composition that provides the toothpaste as similarly described above with respect to FIG. 1.

As shown in FIG. 2D, the collagen-infused dental pet chew includes an exterior composition that includes a hard, smooth exterior with a teardrop die shape in this example. The collagen-infused dental pet chew also includes an interior composition that provides the toothpaste as similarly described above with respect to FIG. 1.

As shown in FIG. 2E, the collagen-infused dental pet chew includes an exterior composition that includes a hard, smooth exterior that is starshaped in this example. The collagen-infused dental pet chew also includes an interior composition that provides the toothpaste as similarly described above with respect to FIG. 1.

Accordingly, the disclosed collagen-infused dental pet chew as described above with respect to FIGS. 1 and 2A-E provides a dental pet chew that provides for a long lasting chew that includes collagen for dental and other health benefits, provides a hard exterior for abrasive teeth cleaning action with a soft toothpaste center/interior, and provides a fast-acting breath freshener, with a protein level of at least 20%.

As such, distinctive features of the disclosed collagen-infused dental pet chews include, for example, a hard ridged exterior for external abrasive action and a soft toothpaste center that releases natural active ingredients during chewing, with collagen infused throughout both layers of the disclosed collagen-infused dental pet chew.

Specifically, the collagen is infused throughout both layers of the disclosed collagen-infused dental pet chew as described above, which supports dental health (e.g., gum strength, tartar reduction), bone, and skin health for pets (e.g., canines) as also similarly described above.

In addition, the disclosed collagen-infused dental pet chew as described above can also include various additional active ingredients including, for example, parsley (e.g., breath freshening), cinnamon (e.g., antibacterial), spearmint oil (breath freshening), cinnamon extract (breath freshening), kelp meal (reduces plaque and tartar), and coconut oil (reduces bacteria, improves oral health).

Also, the protein (e.g., at least 20%) composition of the disclosed collagen-infused dental pet chew as described above in accordance with some embodiments effectively enhances digestibility and longevity of the pet chew. In some embodiments, the formulation is all natural without synthetic chemicals or dyes.

Moreover, in contrast with existing hard exterior and/or toothbrush-shaped chews with purported toothpaste chambers, the disclosed collagen-infused dental pet chew as described above can be manufactured using the above-described co-extrusion process that creates a dual-texture product with collagen infused/integrated throughout both the exterior and interior composition of the pet chew, not confined to an interior chamber or outer layer.

Finally, the disclosed high-collagen formulation provides for various dental and other pet health benefits and digestibility as similarly described above. For example, no chemical/biochemical additives (e.g., hexametaphosphate or enzymes) are included in the disclosed infused-collagen dental pet chews as described above.

Although the foregoing embodiments have been described in some detail for purposes of clarity of understanding, the invention is not limited to the details provided. There are many alternative ways of implementing the invention. The disclosed embodiments are illustrative and not restrictive.

1. A process for preparing a collagen-infused dental pet chew, comprising:
extruding a first mixture to form a hard exterior for the collagen-infused dental pet chew, wherein the first mixture includes collagen as an ingredient;
extruding a second mixture to form a toothpaste in an interior of the hard exterior for the collagen-infused dental pet chew, wherein the second mixture includes collagen as an ingredient and wherein the toothpaste is infused with an active ingredient; and
forming the collagen-infused dental pet chew.

2. The process of claim 1, wherein the first mixture includes an animal protein source as an ingredient.

3. The process of claim 1, wherein the first mixture includes an animal protein source as an ingredient, and wherein the animal protein source includes beef, chicken, or pork.

4. (canceled) The process of claim 1, further comprising:
extruding a second mixture to form a toothpaste in an interior of the hard exterior for the collagen-infused dental pet chew, wherein the second mixture includes collagen as an ingredient.

5. The process of claim 1, wherein the second mixture includes collagen as an ingredient, and wherein the collagen is derived from a source selected from one or more of the following: bovine, porcine, avian, marine, ovine, and plantae.

6. The process of claim 1, wherein the active ingredient is a mineral.

7. The process of claim 1, wherein the collagen is derived from a source selected from one or more of the following: bovine, porcine, avian, marine, ovine, and plantae.

8. The process of claim 1, wherein the active ingredient is a vitamin.

9. The process of claim 1, further comprising:
preparing the first mixture that includes collagen as an ingredient; and
preparing a second mixture that includes collagen as an ingredient, wherein the second mixture is used as a soft toothpaste interior of the collagen-infused dental pet chew.

10. The process of claim 1, wherein forming the collagen-infused dental pet chew further comprises cutting and drying the collagen-infused dental pet chew.

11. A collagen-infused dental pet chew produced by a process comprising the steps of:
extruding a first mixture to form a hard exterior for the collagen-infused dental pet chew, wherein the first mixture includes collagen as an ingredient;
wherein a second mixture is extruded to form a toothpaste in an interior of the hard exterior for the collagen-infused dental pet chew, wherein the second mixture includes collagen as an ingredient and wherein the toothpaste is infused with an active ingredient; and
forming the collagen-infused dental pet chew.

12. The collagen-infused dental pet chew produced by the process of claim 11, wherein the first mixture includes an animal protein source as an ingredient.

13. The collagen-infused dental pet chew produced by the process of claim 11, wherein the first mixture includes an animal protein source as an ingredient, and wherein the animal protein source includes beef, chicken, or pork.

14. (canceled)

15. The collagen-infused dental pet chew produced by the process of claim 11, wherein the second mixture includes collagen as an ingredient, and wherein the collagen is derived from a source selected from one or more of the following: bovine, porcine, avian, marine, ovine, and plantae.

16. The collagen-infused dental pet chew produced by the process of claim 11, wherein the active ingredient is a mineral.

17. The collagen-infused dental pet chew produced by the process of claim 11, wherein the collagen is derived from a source selected from one or more of the following: bovine, porcine, avian, marine, ovine, and plantae.

18. The collagen-infused dental pet chew produced by the process of claim 11, wherein the active ingredient is a vitamin.

19. The collagen-infused dental pet chew produced by the process of claim 11, further comprising:
preparing the first mixture that includes collagen as an ingredient; and
preparing a second mixture that includes collagen as an ingredient, wherein the second mixture is used as a soft toothpaste interior of the collagen-infused dental pet chew.

20. The collagen-infused dental pet chew produced by the process of claim 11, wherein forming the collagen-infused dental pet chew further comprises cutting and drying the collagen-infused dental pet chew.

21. A collagen-infused dental pet chew comprising:
a first mixture forming a hard exterior of the collagen-infused dental pet chew, wherein the first mixture includes collagen as an ingredient; and
a second mixture forming a toothpaste in an interior of the hard exterior for the collagen-infused dental pet chew, wherein the second mixture includes collagen as an ingredient and wherein the toothpaste is infused with an active ingredient.

22. The collagen-infused dental pet chew of claim 21, wherein the first mixture includes an animal protein source as an ingredient.
